(19) United States
(12) Patent Application Publication
(10) Pub. No.: US 2026/0084618 A1
(43) Pub. Date: Mar. 26, 2026

(54) ACTUATOR FOR A REAR VIEW DEVICE OF A VEHICLE, REAR VIEW DEVICE AND VEHICLE

(71) Applicant: MOTHERSON INNOVATIONS COMPANY LIMITED, London (GB)

(72) Inventors: Heesung WOO, Bucheon-si (KR); Ilsung YU, Bucheon-si (KR); Youngmin LEE, Bucheon-si (KR); Tommy PARK, Bucheon-si (KR); Seungtae YUN, Bucheon-si (KR)

(21) Appl. No.: 19/334,107

(22) Filed: Sep. 19, 2025

(30) Foreign Application Priority Data
Sep. 23, 2024 (DE) 102024127369.0

(51) Int. Cl. B60R 1/074; B60R 1/06

(52) U.S. Cl. CPC B60R 1/074; B60R 1/0617

(57) ABSTRACT

An actuator for a rear view device of a vehicle having a body defining a folding axis and an actuator housing being rotatably and axially displaceably supported by the body and a drive assembly. Wherein a clutch gear of the drive assembly is rotatably and axially displaceably supported by the body and has at least one housing catch axially coupling the clutch gear to the actuator housing while allowing a relative rotation of the clutch gear and actuator housing and wherein a shaft section extends along the folding axis and comprises at least one groove circumferentially about a top surface of the shaft section and wherein an interior of an upper portion of the actuator housing comprises at least one slot having at least one pin affixed in at least one slot and engaging at least one of the grooves on the top surface of the shaft section.

### CROSS-REFERENCE TO RELATED APPLICATION(S)

This application claims the benefit of German Patent Application No. DE 102024127369.0, filed Sep. 23, 2024, the content of which is hereby incorporated by reference in its entirety.

### TECHNICAL FIELD

The present disclosure relates generally to an actuator for a rear view device of a vehicle and specifically to an actuator providing a fold and lift function. The present disclosure also relates to a rear view device comprising such actuator and to a vehicle comprising at least one of such rear view devices.

### BACKGROUND

A rear view device of a vehicle is usually mounted on a base frame arranged on the exterior of a vehicle door or body and allows a rear view to a drive of the vehicle. Some rear view devices have a so-called powerfold actuator for automatically folding and unfolding the rear view device. In some instances, the powerfold actuator has an actuator base to be mounted to a base frame, an actuator housing supporting a mirror housing being rotatably coupled to the actuator base and a drive assembly being configured for automatically pivoting the actuator housing relative to the actuator base about a folding axis between a first angular position and a second angular position which is an unfolded position of the rear view device.

In the unfolded position, the rear view device protrudes from the vehicle door and extends substantially transverse relative to the forward driving direction of the vehicle. As the rear view device is in the unfolded position during a drive of the vehicle the unfolded position is often referred to as a drive position.

In the folded position, the rear view device is aligned with the vehicle door and extends opposite to the forward driving direction of the vehicle. As the rear view device is in the folded position during a parking of the vehicle the folded position is often referred to as a parking position.

The powerfold actuator enables the rear view device for unfolding and folding automatically, the powerfold actuator should as well allow for manually pivoting the rear view device between the first angular position and the second angular position, for instance, in case of a defect or malfunction of the powerfold actuator.

Additionally, the powerfold actuator is usually required to allow for manually over-folding the rear view device, for example, to manually pivot the rear view device into a third angular position is a so-called over-folded position of the rear view device.

In the over-folded position, the rearview device is substantially aligned with the vehicle door as it is in the folded position. However, in the over-folded position the rear view device extends in the forward driving direction of the vehicle, i.e. the orientation of the rear view device in the over-folded position is substantially opposite to the orientation of the rear view device in the folded position. By pivoting from the unfolded position into the over-folded position, the unfolded rearview device may yield to a moment working in the forward driving direction of the vehicle in order to avoid breaking of the rearview device or the powerfold actuator due to the moment.

Another requirement to be met by a rearview device is causing as little wind noise as possible during a drive of the vehicle, i.e. in the unfolded position of the rear view device, and pivoting very easily thereby producing as little wear as possible. While pivoting of the rear view device is very easy and produces little wear if there is a gap between the actuator housing and the actuator base, it is just the gap between the actuator housing and the actuator base to cause noise when wind is applied thereto. Additionally, wear is also prevented if there is a pin located in an interior portion of an upper actuator housing having at least one slot configured to receive the pin. The pin interfaces with an upper portion of a shaft having at least one groove and a flat top surface. The pin accepts some of the stress between the actuator housing and the base causing there to be minimal wear on both components.

In order to overcome these contravening issues, the powerfold actuator may have a lift mechanism. The lift mechanism is configured to axially displace the actuator housing relative to the actuator base along the folding axis between a first axial position, the actuator housing therein abutting the actuator base without a gap between the actuator housing and the actuator base, and a second axial position, the actuator housing therein being at a distance from the actuator base and forming a gap between the actuator housing and the actuator base. The lift mechanism may lower the actuator housing in the drive position of the rear view device and lift the actuator housing for any pivoting action. The gap formed allows the pin to disengage from one of the grooves and then reengage with the next groove as the actuator housing rotates about the actuator base.

The lift mechanism may have one or more pairs of circular cam tracks. The cam tracks of each pair are arranged to face each other and configured to more or less engage each other dependent on their relative angular position. Thus, rotating the cam tracks of a pair relative to each other causes an axial distance between the cam tracks to vary, the axial distance variation providing the actuator housing with the desired axial displacement effect.

The drive assembly may integrate the lift mechanism and provide a combined fold and lift function for the powerfold actuator. However, providing a powerfold actuator with a lift mechanism usually results in a high mass and a high mechanical complexity of the powerfold actuator.

From EP 2 574 504 A1, a car outside mirror device is known to have a shaft, a transmission housing, a set of a motor, a deceleration mechanism and a clutch mechanism, an electrically driven rotation range limiting mechanism and a holding mechanism. The holding mechanism is provided between a shaft and a housing. This holding mechanism is arranged in a non-contact state with respect to the shaft and the housing in an area where a mirror assembly rotates between a use location and a storage location, and is arranged in a contact state with respect to the shaft and the housing to hold the mirror assembly at the use location when the mirror assembly is positioned at the use location. As a result, the present invention is compatible with preventing the application of a load to an electrically driven storage unit and holding the mirror assembly in a manner so as to be free of vibration.

US 2013/0321941 A1 teaches an adjustment tool for an exterior mirror unit for a vehicle. The adjustment instrument comprises a housing that is pivotally adjustable between a parking position, a drive position and a flip position with respect to a base. The adjusting instrument further comprises an electric drive unit provided in the housing and a drive ring for coupling to the electric drive unit.

From DE 698 22 701 T2, an exterior rear-view mirror with a mirror head is known, which is rotatably mounted on a pivot that is attached to a mounting bracket. A catch holds the mirror head in a desired position relative to the mounting bracket. A spring acts between the mounting bracket and the mirror head to hold the latch in its locked position. An actuator is driven by an electric motor drive so that during initial operation, while the latch is engaged to resist rotation of the mirror head, a force is applied to the spring causing movement of the mirror head to release the latch. During subsequent operation, the actuator rotates the mirror head around the journal.

The US 2007/0084707 A1 teaches a hinge actuator comprising a first part that is pivotally connected to a second part and an electric drive for pivoting the parts relative to each other. The first and second parts comprise stops that cooperate in a first pivoting direction to define a position of the actuator parts. A coupling is provided between the first and second parts, so that in a first position the first part and the second part are connected via the drive and, driven by the drive, can be pivoted relative to each other, and a second position in which the first part and the second part are not connected via the drive and can be manually pivoted relative to each other.

### SUMMARY OF THE DISCLOSURE

It is desirable to provide an actuator for a rear view device of a vehicle which allows for pivoting manually, supports over-folding, has a lift mechanism and, at the same time, has a low mass and a low complexity.

In an example, a rear view device actuator having an automatic fold and lift function which has a low mass and a low complexity is provided.

In an example, an actuator for a rear view device of a vehicle includes a body defining a folding axis for the rear view device relative to the vehicle, an actuator housing being rotatably and axially displaceably supported by the body and a drive assembly being supported by the actuator housing and being configured for rotating the actuator housing relative to the body about the folding axis between a first angular position and a second angular position and for axially displacing the actuator housing relative to the body along the folding axis between a first axial position and a second axial position. Wherein the drive assembly has a clutch gear being rotatably and axially displaceably supported by the body and has at least one housing catch axially coupling the clutch gear to the actuator housing while allowing a relative rotation of the clutch gear and actuator housing. Wherein a shaft section extends along the folding axis and comprises at least one groove circumferentially about a top surface of the shaft section and wherein an interior of an upper portion of the actuator housing comprises at least one slot having at least one pin affixed in at least one slot and engaging at least one of the grooves on the top surface of the shaft section.

A rear view device may comprise one or more mirror elements or one of more cameras providing views of a rear traffic.

In another example, the actuator further comprising a folding cam track extending peripherally and interacting with the body and the actuator housing, the folding cam track configured to move the body and the actuator housing to the second angular position, the folding cam track of the body having a folding stop catch with a shoulder and the folding cam track of the actuator housing having a folding stop detent; and wherein the body and the clutch gear each having a lifting cam track extending peripherally and interacting with each other for defining a lifting stop and a lifting stroke, the lifting cam track of the body having a lifting stop catch and the lifting cam track of the clutch gear having a lifting stop detent.

In a further example, the upper portion of the housing having the interior and an exterior and wherein the interior of the upper portion comprises the at least one slot circumferentially spaced from each other about the folding axis and engages with the top surface of the shaft section and the upper portion of the actuator housing is configured to rotate axially about the shaft section.

In yet another example, the at least one slot of the interior of the upper portion housing comprise at least one pin and the at least one pin comprises metal, plastic and combinations thereof.

In yet a further example, the body and the actuator housing rotate relative to each other and the at least one pin of the interior of the upper portion of the actuator housing lifts up and out of at least one of the grooves. As the body and actuator housing continue to rotate the at least one pin travels along a flat top surface of the shaft section and engages with at least one of the grooves.

In another example the actuator includes the body having a base section and the shaft section being arranged axially adjacent to the base section, the base section having at least one base fastening means for connecting the body to a base frame of at least one of a door of a vehicle and the shaft section extending through a through-hole of the actuator housing. Wherein the base section and the shaft section are integrally formed, or the body is configured two-part and the base section and the shaft section are separately formed and connected by a bayonet lock, the base section having the bayonet mount and the shaft section having the bayonet catch or vice versa.

In yet another example, the drive assembly has a drive train for rotating the actuator housing about a folding axis and displacing the actuator housing along the folding axis; wherein the at least one slot of the interior of the upper portion of the actuator housing is axially displaced and the metal pin is simultaneously axially displaced from the at least one of the grooves on the top surface of the shaft section.

In an example, the drive train comprises an electric motor, a printed circuit board mounted and electrically connected to the electric motor and, for rotatably coupling the clutch gear to the electric motor, a first worm gear being torque-proof fastened to a drive shaft of the electric motor, a second worm gear being engaged with the clutch gear, and a spur gear being engaged with the first worm gear and torque-proof fastened to the second worm gear.

In another example, a first angular difference between the first angular position and the second angular position is in a range from 20° to 90°.

In another example, the drive assembly has a retainer ring, a clutch ring and a spring, and the spring being supported between the retainer ring and the clutch ring being a wave spring.

In a further example, the actuator housing has a through-hole being penetrated by the body and at least one mirror fastening means for detachably connecting a mirror housing of a rear view device thereto.

A rear view device comprising the actuator described in any of the preceding examples.

A vehicle comprising at least one rear view device in any of the preceding examples.

### BRIEF DESCRIPTION OF THE DRAWINGS

The foregoing summary, as well as the following detailed description, will be better understood when read in conjunction with the appended drawings. For the purpose of illustration, certain examples of the present description are shown in the drawings. It should be understood, however, that the disclosure is not limited to the precise arrangements and instrumentalities shown. The accompanying drawings, which are incorporated in and constitute a part of this specification, illustrate an implementation of system, apparatuses, and methods consistent with the present description and, together with the description, serve to explain advantages and principles consistent with the disclosure. The figures are not necessarily drawn to scale. Like numbers used in the figures refer to like components. However, it will be understood that the use of a number to refer to a component in a given figure is not intended to limit the component in another figure labelled with the same number.

FIG. 1 is a perspective illustration of a front of a vehicle;

FIG. 2 is a perspective illustration of an actuator;

FIG. 3 is a schematic illustration of a perspective view of the actuator shown in FIG. 2 with the cover being removed;

FIG. 4 is a schematic illustration of a top view of the actuator shown in FIG. 2 in a first angular position, a second angular position, and third angular position;

FIG. 5 is a schematic illustration of a lateral view of the actuator shown in FIG. 2;

FIG. 6 is a schematic illustration of a perspective view of the gear train of the actuator shown in FIG. 2;

FIG. 7 is a schematic illustration of a perspective partial view of a drive assembly of the actuator shown in FIG. 2.

FIG. 8 is a cross-sectional illustration of the actuator from FIG. 2;

FIG. 9 is a close-up illustration of the circle D from FIG. 8;

FIG. 10 is an illustration of a pin disengaging from a groove;

FIG. 11 is a schematic illustration of an interior portion of the actuator cover part; and

FIG. 12 is a schematic illustration of an exploded view of an actuator according to another embodiment.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

It is to be understood that the phraseology and terminology employed herein are for the purpose of description and should not be regarded as limiting. For example, the use of a singular term, such as, “a” is not intended as limiting of the number of items. Also, the use of relational terms, such as but not limited to, “top,” “bottom,” “left,” “right,” “upper,” “lower,” “down,” “up,” “side,” are used in the description for clarity and are not intended to limit the scope of the disclosure or the appended claims. Further, it should be understood that any one of the features can be used separately or in combination with other features. Other systems, methods, features, and advantages of the disclosure will be or become apparent to one with skill in the art upon examination of the detailed description. It is intended that all such additional systems, methods, features, and advantages be included within this description, be within the scope of the present disclosure, and be protected by the accompanying claims.

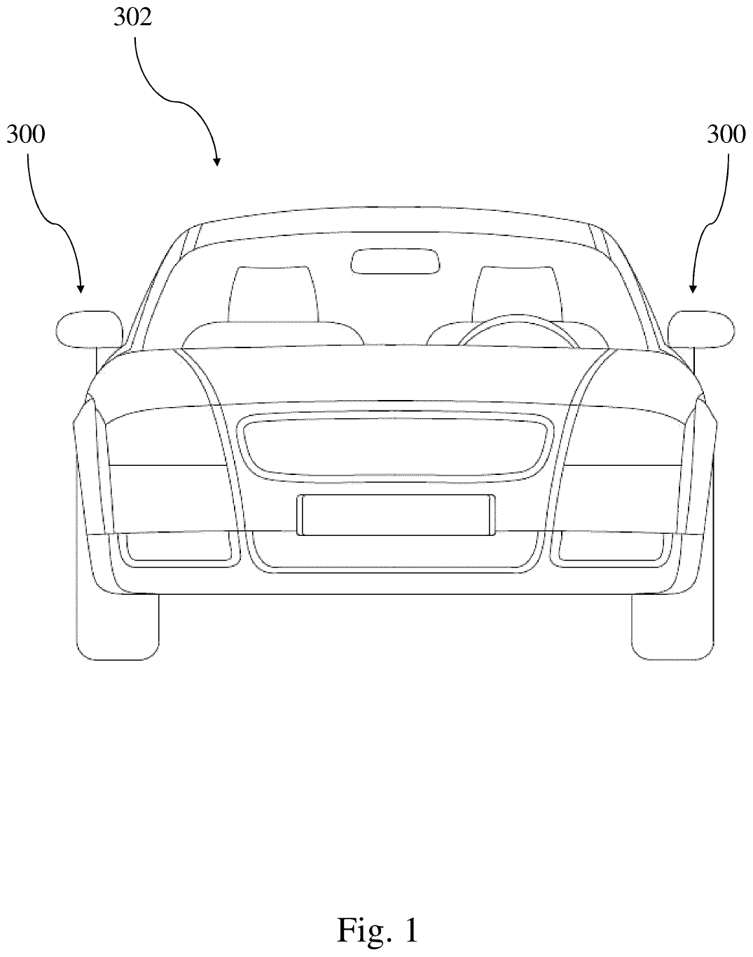

FIG. 1 is a perspective illustration of a front of a vehicle 302. The vehicle may comprise at least one rear view device 300. As shown in FIG. 1, the vehicle 302 comprises two rear view devices 300. A driver side or right rear view device 300 and a passenger side or left rear view device 300.

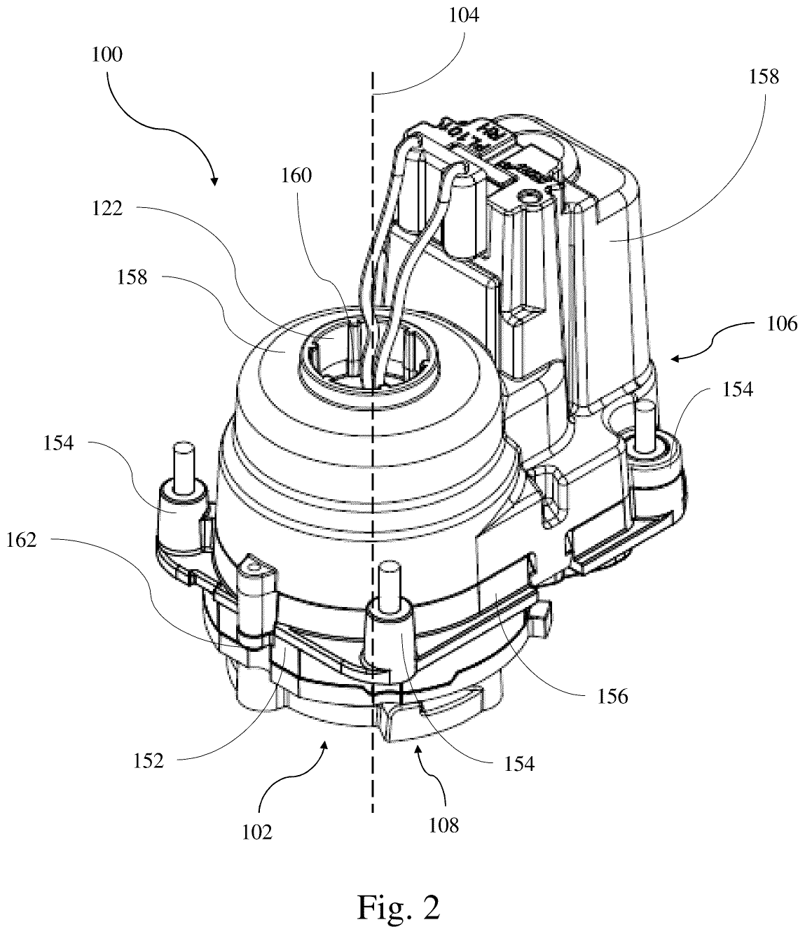

FIG. 2 shows a perspective view of an actuator 100 according to an embodiment which may be used for mounting a rear view device 300 to a base frame (not shown) of a door of a vehicle 302. The actuator 100 has a body 102 defining a folding axis 104 for the rear view device 300 of the vehicle 302 and is configured for being mounted on a right-hand side of the vehicle 302.

The body 102 has a base section 152 with three base fastening means 154 for connecting the body 102 to the base frame of the door of the vehicle 302. The body further defines a shaft section 122 being arranged axially adjacent to the base section 152. The base section 152 and the shaft section 122 are integrally formed from a plastic or metal and have a substantially cylindrical shape. Further, the base section 152 and the shaft section 122 differ by a diameter of the cylinder, wherein the base section 152 has a larger diameter than the shaft section 122.

The actuator 100 also has an actuator housing 106 being rotatably and axially displaceably borne by the body 102. The actuator housing 106 has a through hole 160 being penetrated by the body 102. For example, the shaft section 122 extends through the through hole 160 of the actuator housing 106 and the mirror fastening means 162 for detachably connecting a mirror housing of the rear view device 300 thereto. The actuator housing 106 is configured with two-part and has a base part 156 and a cover part 158 being detachably connected to each other and forming the actuator housing 106.

The base part 156 and the cover part 158 each have corresponding fastening means, wherein the through hole 160 and the mirror fastening means 162 are formed in the base part 156. The cover part 158 of the actuator housing 106 has a cylindrical section accommodating the shaft section 122 of the body and having a diameter in a range from 15 mm to 20 mm for different embodiments.

A retainer ring 188 is axially fastened to the shaft section 122 by press-fitting, the shaft section 122 having a peripheral channel 206 and the retainer ring 188 having a plurality of catches 208 engaging the peripheral channel 206. The spring 192 is supported between retainer ring 188 and the clutch ring 190, thus biasing the clutch ring 190, the clutch gear 118 and the shaft cam ring 176 to the base section 152 of the body 102.

The actuator housing 106 may have a height being measured in the axial direction in a range from 60 mm to 90 mm for different embodiments. The actuator housing 106 may have a width being measured in a first radial direction in a range of from 40 mm to 70 mm for different embodiments. The actuator housing 106 may have a length or depth being measured in a second radial direction perpendicular to the first radial direction in a range from 60 mm to 100 mm for different embodiments.

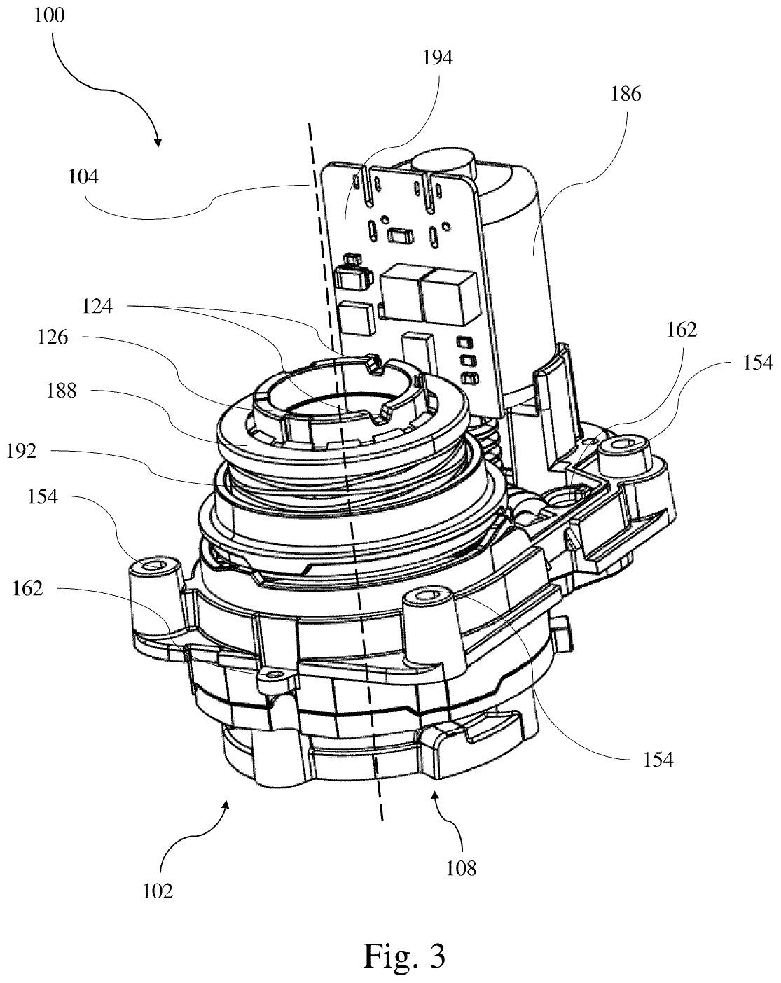

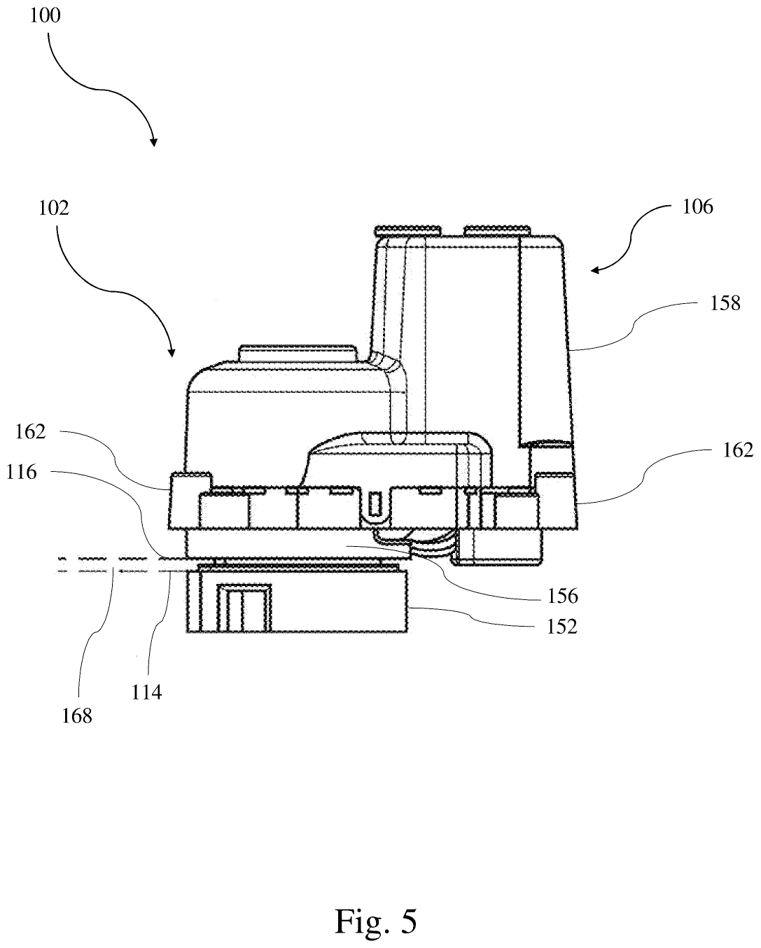

FIG. 3 shows a perspective view of the actuator 100 with the cover part 158 removed for accessing the interior structure of the actuator 100. The actuator 100 has a drive assembly 108 being completely arranged within the actuator housing 106 and supported by the actuator housing 106, i.e. the actuator 100 is a so-called powerfold actuator. The drive assembly 108 is configured for rotating the actuator housing 106 relative to the body 102 along the folding axis 104 between a first angular position 110 and a third angular position 113 (as shown in FIG. 3) and for axially displacing the actuator housing 106 relative to the body 102 along the folding axis 104 between the first axial position 114 and the second axial position 116 (as shown in FIG. 5).

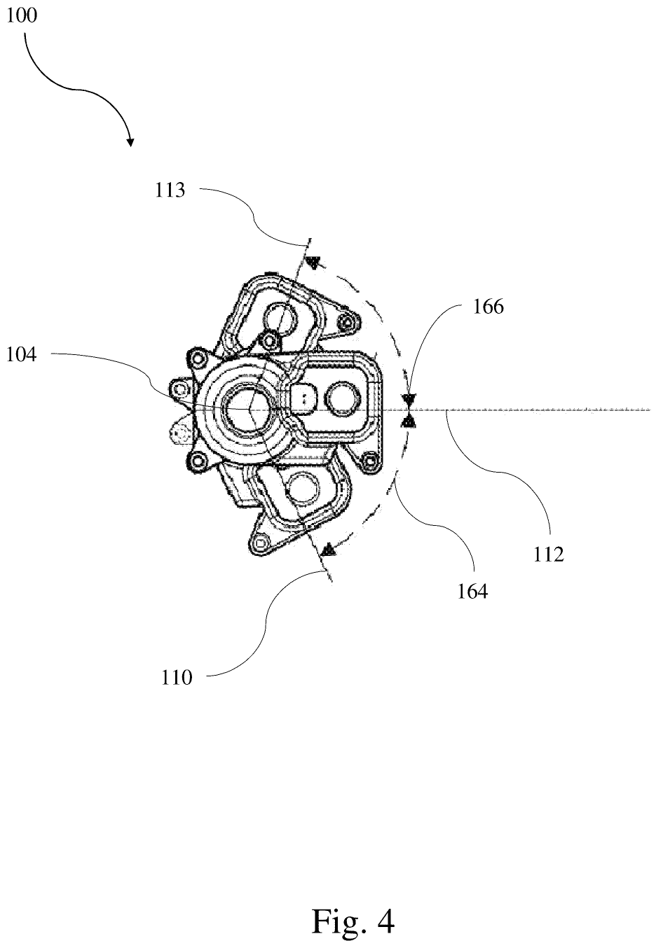

FIG. 4 shows a top view of the actuator 100 in a first angular position 110, i.e. a folded position of the rear view device 300, a second angular position 112, i.e. an unfolded position of the rear view device 300, and a third angular position 113, i.e. an over-folded position of the rear view device 300. A first angular difference 164 between the first angular position 110 and the second angular position 112 may be 75°, and may also be in the range from 20° to 90° for different embodiments. A second angular difference 166 between the first angular position 110 and the third angular position 113 may be 165° and may also be up to 240° for different embodiments.

FIG. 5 shows a lateral view of the actuator 100. The actuator housing 106 is in a second axial position 116 forming a gap 168 between the base part 156 of the actuator housing 106 and the base section 152 of the body 102. In a first axial position 114, the base part 156 of the actuator housing 106 abuts the base section 152 of the body 102 substantially without any gap 168.

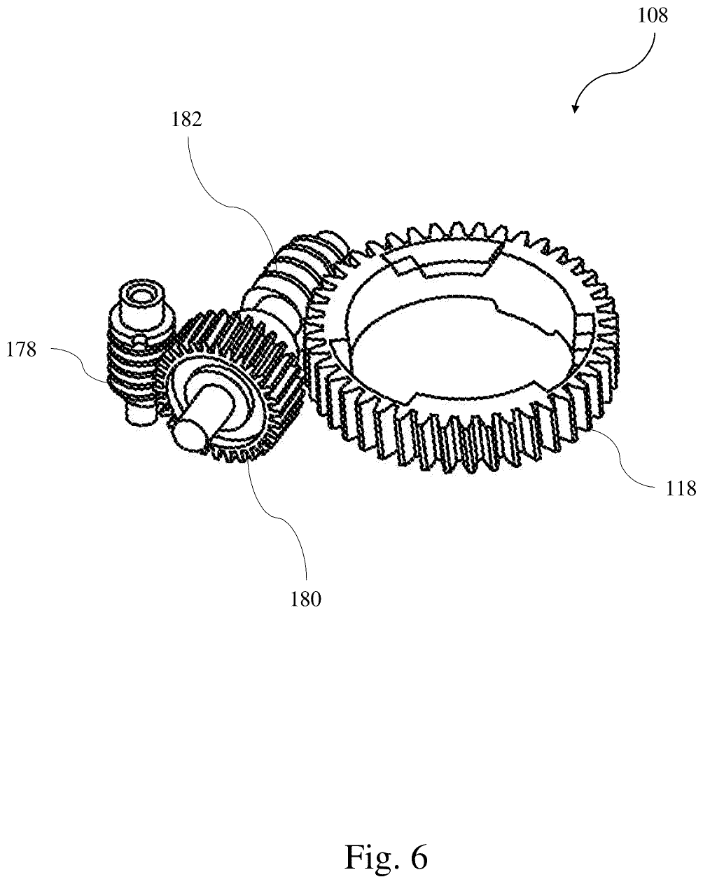

FIG. 6 shows a perspective partial view of a drive train of the actuator 100. The drive train, for rotatably coupling the clutch gear 118 to the electric motor 186, has a first worm gear 178 being torque-proof fastened to the drive shaft of the electric motor 186, a second worm gear 182 being engaged with a clutch gear 118, and a spur gear 180 being engaged with the first worm gear 178 and torque-proof fastened to the second worm gear 182. The first worm gear 178 comprises a plastic or consists thereof. The spur gear 180 comprises a plastic of consists thereof. The second worm gear 182 comprises a metal or consists thereof. The second worm gear 182 and the spur gear 180 are rotatable about an axis extending perpendicular to both the drive shaft and the folding axis 104.

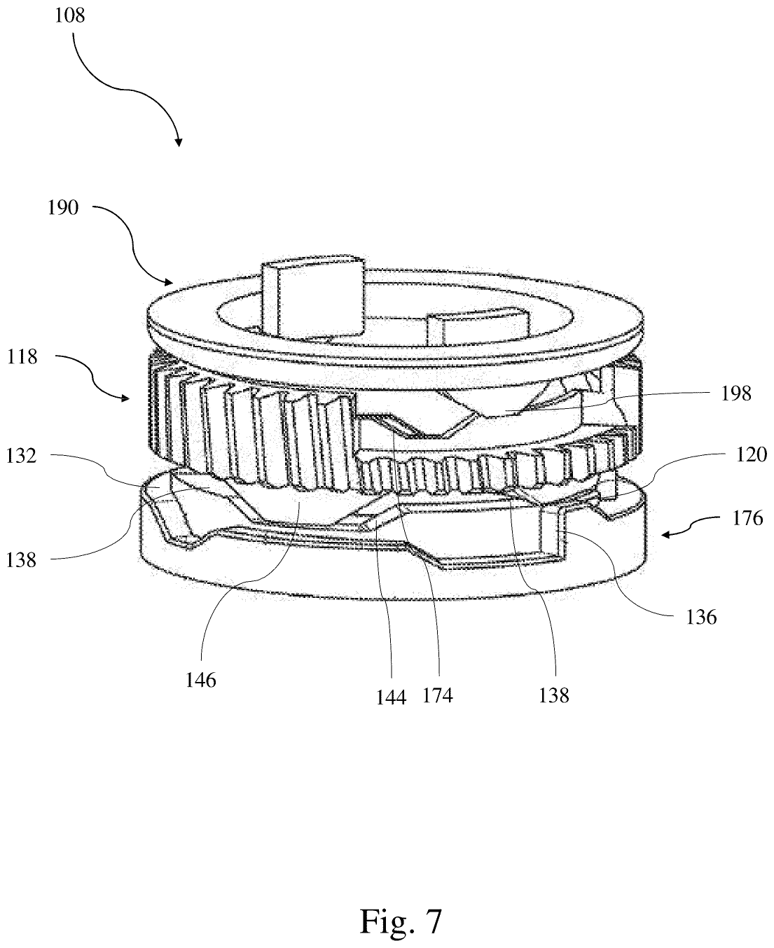

FIG. 7 shows a schematic illustration of a perspective partial view of the drive assembly 108 of the actuator 100.

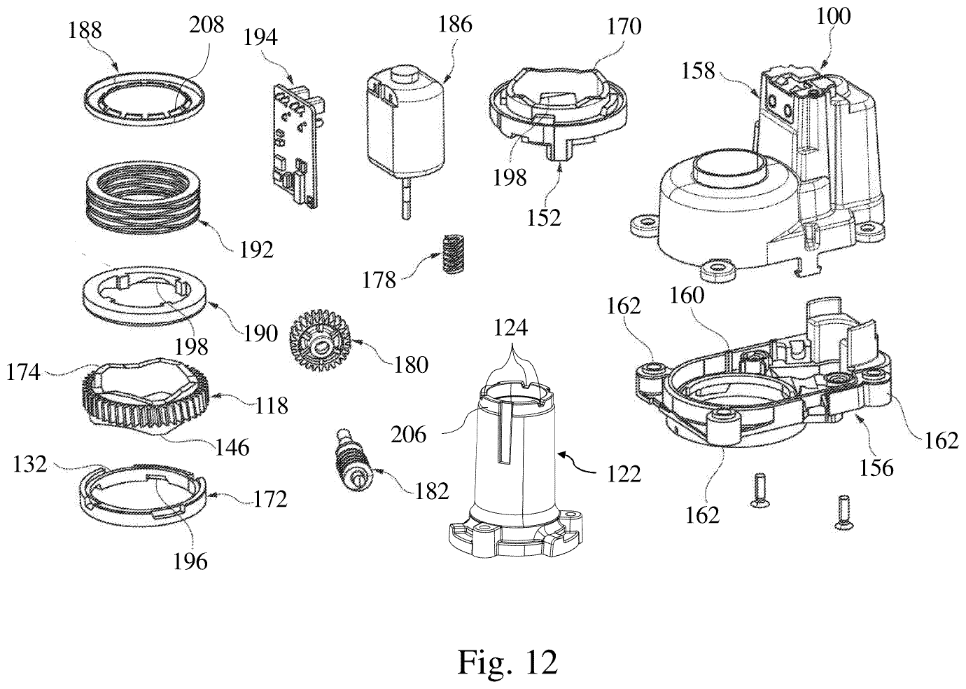

The body 102 (not shown in FIG. 7, see FIG. 2) and the clutch gear 118 each having a lifting cam track 138, 170 (See FIG. 12) extending peripherally around the body 102 and interacting with each other for defining a lifting stop and a lifting stroke. The lifting stroke determines the width of a gap 168. The lifting cam track 138 of the body 102 has a lifting stop catch 144 and the lifting cam track 138 of the clutch gear 108 has a lifting stop detent 146.

The lifting cam tracks 138, 170 are radially arranged within the folding cam tracks 132, 172 (See FIG. 12) of the actuator housing 106 and the body 102 respectively. The lifting cam tracks 138, 170 and the folding cam tracks 132, 172 are also axially arranged at the same position. The lifting cam track 138 of the clutch gear 118 completely engages the lifting cam track 170 of the body 102, i.e. the lifting stop catch 144 engages the lifting stop detent 146 which corresponds to the first axial position 114 of the actuator housing 106.

The folding cam track 172 of the body 102 and the lifting cam track 170 of the body are formed on a shaft cam ring 176 of the drive assembly 108. The shaft cam ring 176 is torque-proof connected to the body 102 by means of a plurality of angular positioning detents 196 (Sec FIG. 12) of the shaft cam ring 176 engaging in a plurality of matching angular positioning catches 198 of the body 102.

The clutch ring 190 and the clutch gear 118 each have a clutch cam track extending peripherally and interacting with each other for controlling an angular coupling between the clutch ring 190 and the clutch gear 118. The clutch cam track of the clutch ring 190 has a plurality of angular positioning catches 198 and the clutch cam track of the clutch gear 118 has a plurality of clutch detents 174 for engaging the angular positioning catches 198 of the clutch ring 190. Additionally, the clutch detents and the angular positioning catches may be associated reversely for different embodiments.

In summary, the clutch gear 118 is the central part of the drive assembly 108 having an outer helical gear for interacting with the drive train and forwarding a moment, a clutch cam track for interacting with the clutch ring 190 and controlling a relative angular position of the clutch gear 118 and the body 102, a lifting cam track 170 for interacting with the body 102 and controlling a relative axial position of the clutch gear 118 and the body 102 and a housing catch 120 for interacting with the actuator housing 106 and controlling a relative axial position of the actuator housing 106 and the body 102, i.e. the clutch gear 118 is configured for four different interactions in total.

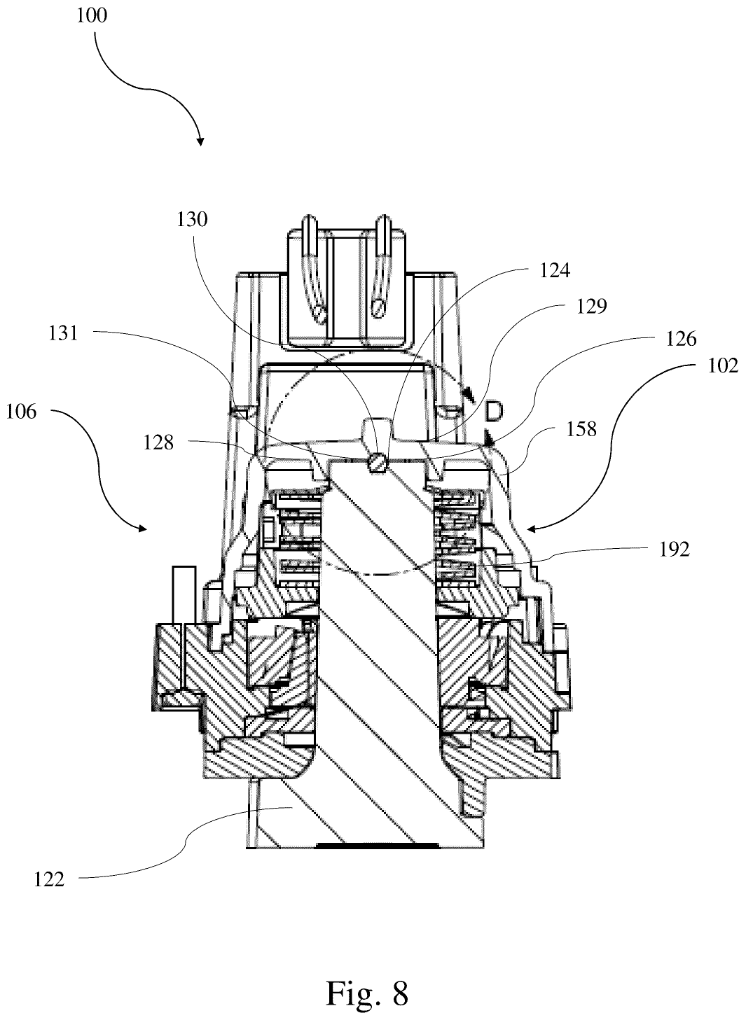

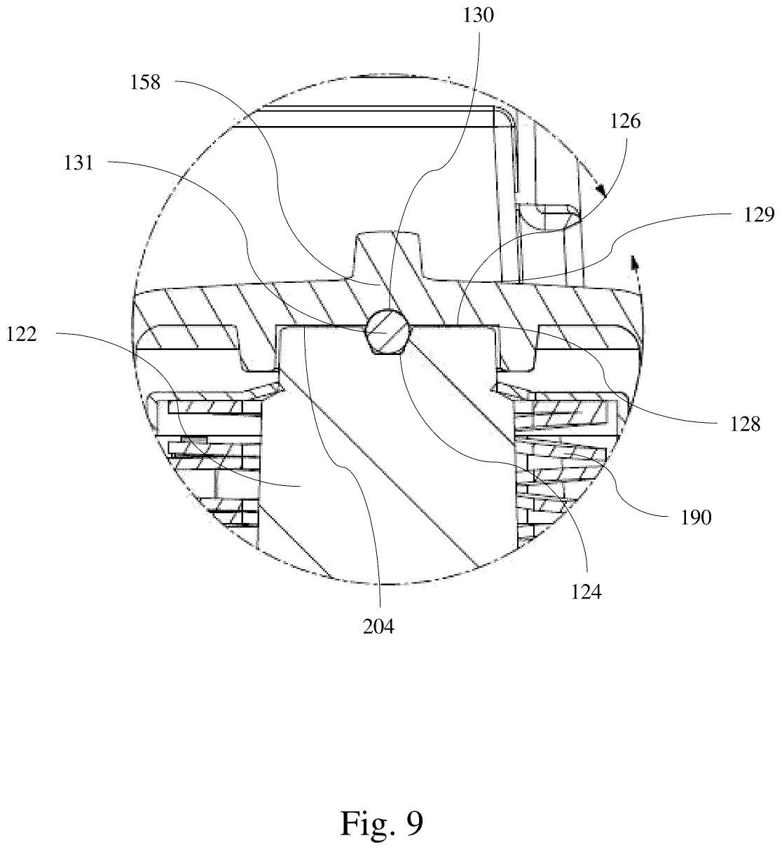

FIG. 8 is a cross-sectional illustration of the actuator 100. FIG. 9 is a magnified view of the circle D shown in FIG. 8. The actuator 100 comprising the body 102, the actuator housing 106 and the shaft section 122. The shaft section 122 may extend along the folding axis 104 in a substantially vertical direction. The shaft section 122 may further comprise a top surface 126 and the top surface 126 may comprise at least one groove 124. The at least one groove 124 being circumferentially spaced about the top surface 126 of the shaft section 122. FIGS. 8 and 9 show an interior portion 128 and an exterior portion 129 of the cover part 158. The interior portion 128 of the cover part 158 may comprise at least one slot 130 circumferentially spaced about the folding axis 104 on an upper surface 204 of the interior portion 128 of the cover part 158. The slots 130 are configured to hold at least one pin 131. The pin 131 may engage with at least one groove 124 of the top surface 126 of the shaft section 122.

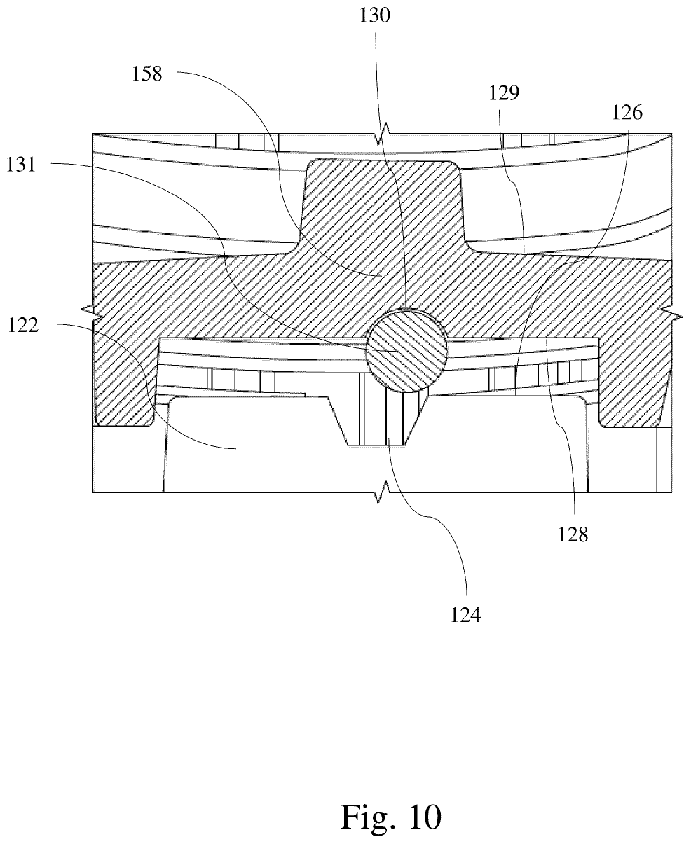

FIG. 10 shows a perspective view as the actuator 100 is moving from the first angular position 110 to the second angular position 112. As the actuator 100 moves from the first angular position 110 to the second angular position 112, the actuator 100 simultaneously moves from the first axial position 114 to the second axial position 116. This causes the cover part 158 to lift up in a vertical direction allowing the pin 131, that was engaged in the groove 124 of the top surface 126 of the shaft section 122, to disengage the groove 124 and come into contact with the top surface 126 of the shaft section 122. The pin 131 absorbs some of the force and weight of the rear view device 300, causing less wear and stress on the drive assembly 108 and in turn, prolonging the life and function of the actuator 100.

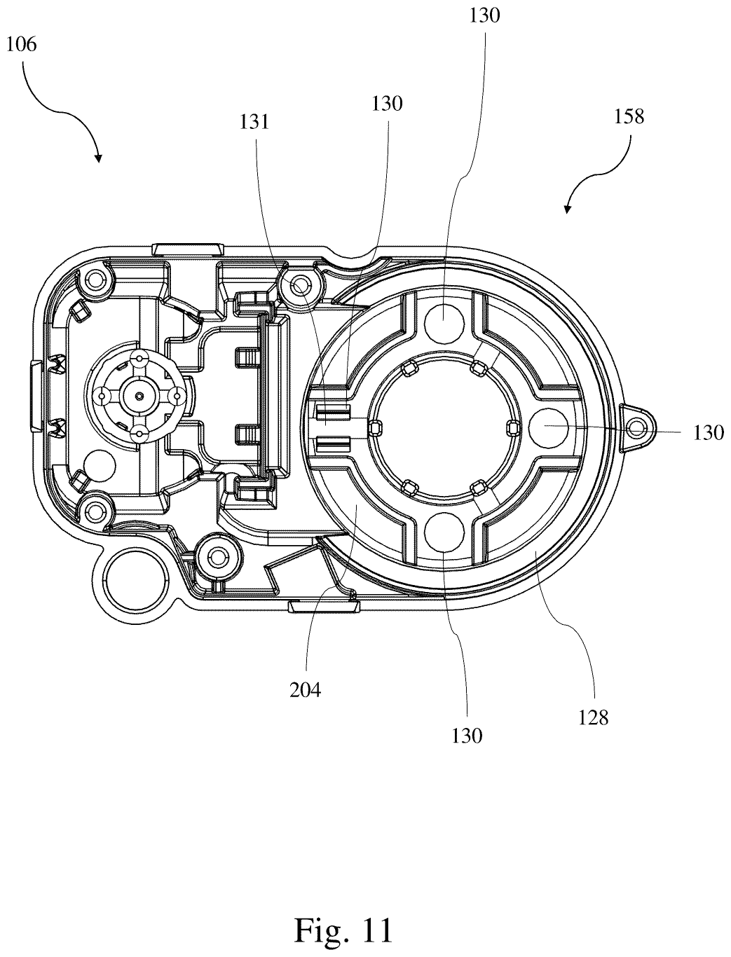

FIG. 11 is a schematic of the interior portion 128 of the actuator 100 cover part 158. The actuator 100 cover part 158 may comprise at least one slot 130 configured to hold at least one pin 131. Although, the figure shows only one pin 131, it is contemplated that multiple pins 131 could be used in alternate embodiments.

FIG. 12 shows an exploded view of the actuator 100 for the rear view device 300 for the vehicle 302. The actuator 100 comprises the cover part 158 that is fastened to the base part 156. The actuator 100 further comprises the base section 152, a retainer ring 188 having a plurality of catches 208 to secure the retainer ring 188 to the peripheral channel 206 in the shaft section 122. The retainer ring 188 secures the spring 192, particularly a wave spring, the clutch ring 190 the clutch gear 118 and the shaft cam ring 176 to the shaft section 122. The actuator 100 further comprises the printed circuit board (PCB) to control the electric motor 186. The electric motor 186 may power and rotate the actuator in turn engaging the gear train (see FIG. 6) which comprises the first worm gear 178, the spur gear 180, the second worm gear 182 and the clutch gear 118.

Unless otherwise indicated, all numbers expressing feature sizes, amounts, and physical properties used in the specification and claims are to be understood as being modified by the term “about”. Accordingly, unless indicated to the contrary, the numerical parameters set forth in the foregoing specification and attached claims are approximations that can vary depending upon the desired properties sought to be obtained by those skilled in the art utilizing the teachings disclosed herein.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

Furthermore, the features of the disclosure disclosed in this specification, the claims and the drawings may be employed both individually and in any possible combination for practicing the disclosure in its various exemplary embodiments. In particular, all claim feature combinations, irrespective of the claim dependencies, are covered with this application.

1. An actuator for a rear view device of a vehicle comprising:
a body defining a folding axis for the rear view device relative to the vehicle;
an actuator housing comprising a base part and a cover part, and the actuator housing being rotatably and axially displaceably supported by the body;
a drive assembly being supported by the actuator housing and being configured for rotating the actuator housing relative to the body about the folding axis between a first angular position and a second angular position and for axially displacing the actuator housing relative to the body along the folding axis between a first axial position and a second axial position; and
wherein a clutch gear of the drive assembly is rotatably and axially displaceably supported by the body and has at least one housing catch axially coupling the clutch gear to the actuator housing while allowing a relative rotation of the clutch gear and actuator housing; and
wherein a shaft section extends along the folding axis and comprises at least one groove circumferentially about a top surface of the shaft section and wherein an interior portion of the cover part comprises at least one slot having at least one pin affixed in at least one slot and engaging at least one groove on the top surface of the shaft section.

2. The actuator of claim 1, further comprising a folding cam track extending peripherally and interacting with the body and the actuator housing, the folding cam track configured to move the body and the actuator housing to the second angular position, the folding cam track of the body having a folding stop catch with a shoulder and the folding cam track of the actuator housing having a folding stop detent; and wherein the body and the clutch gear each having a lifting cam track extending peripherally and interacting with each other for defining a lifting stop and a lifting stroke, the lifting cam track of the body having a lifting stop catch and the lifting cam track of the clutch gear having a lifting stop detent.

3. The actuator of claim 1, wherein the cover part of the actuator having the interior portion and an exterior portion; wherein the interior portion comprises the at least one slot circumferentially spaced from each other about the folding axis and engages with the top surface of the shaft section; and the cover part is configured to rotate axially about the shaft section.

4. The actuator of claim 1, wherein the at least one slot of the interior portion of the cover part comprise at least one pin and the at least one pin comprises metal, plastic and combinations thereof.

5. The actuator of claim 1, wherein the interior portion of the cover part comprises an integrated plastic structure that engages with at least one of the grooves on the top surface of the shaft section.

6. The actuator of claim 1, wherein the body and the actuator housing rotate relative to each other and the at least one pin of the interior portion of the cover part lifts up and out of at least one of the grooves; and as the body and actuator housing continues to rotate the at least one pin travels along a flat surface of the top surface of the shaft section and engages with at least one of the grooves.

7. The actuator of claim 1, wherein the body has a base section and the shaft section being arranged axially adjacent to the base section, the base section having at least one base fastening means for connecting the body to a base frame of at least one of a door of a vehicle and the shaft section extending through a through-hole of the actuator housing.

8. The actuator of claim 7, wherein the base section and the shaft section are integrally formed, or the body is configured two-part and the base section and the shaft section are separately formed and connected by press-fitting, the shaft section having a peripheral channel and a retainer ring having a plurality of catches engaging the peripheral channel.

9. The actuator of claim 1, wherein the drive assembly has a drive train for rotating the actuator housing about a folding axis; and displacing the actuator housing along the folding axis; wherein the at least one slot of the interior portion of the cover part is axially displaced; and the pin is simultaneously axially displaced from the at least one of the grooves on the top surface of the shaft section.

10. The actuator of claim 9, wherein the drive train comprises an electric motor, a printed circuit board mounted and electrically connected to the electric motor and, for rotatably coupling the clutch gear to the electric motor, a first worm gear being torque-proof fastened to a drive shaft of the electric motor, a second worm gear being engaged with the clutch gear, and a spur gear being engaged with the first worm gear and torque-proof fastened to the second worm gear.

11. The actuator of claim 1, wherein a first angular difference between the first angular position and the second angular position is in a range from 20° to 90°.

12. The actuator of claim 1, wherein the drive assembly has a retainer ring, a clutch ring and a spring, and the spring being supported between the retainer ring and the clutch ring being a wave spring.

13. The actuator of claim 1, wherein the actuator housing has a through-hole being penetrated by the body and at least one mirror fastening means for detachably connecting a mirror housing of a rear view device thereto.

14. A rear view device comprising an actuator for a rear view device of a vehicle, the actuator comprising:
a body defining a folding axis for the rear view device relative to the vehicle;
an actuator housing comprising a base part and a cover part, and the actuator housing being rotatably and axially displaceably supported by the body;
a drive assembly being supported by the actuator housing and being configured for rotating the actuator housing relative to the body about the folding axis between a first angular position and a second angular position and for axially displacing the actuator housing relative to the body along the folding axis between a first axial position and a second axial position; and
wherein a clutch gear of the drive assembly is rotatably and axially displaceably supported by the body and has at least one housing catch axially coupling the clutch gear to the actuator housing while allowing a relative rotation of the clutch gear and actuator housing; and
wherein a shaft section extends along the folding axis and comprises at least one groove circumferentially about a top surface of the shaft section and wherein an interior portion of the cover part comprises at least one slot having at least one pin affixed in at least one slot and engaging at least one groove on the top surface of the shaft section.

15. A vehicle comprising at least one rear view device having an actuator, the actuator comprising:
a body defining a folding axis for the rear view device relative to the vehicle;
an actuator housing comprising a base part and a cover part, and the actuator housing being rotatably and axially displaceably supported by the body;
a drive assembly being supported by the actuator housing and being configured for rotating the actuator housing relative to the body about the folding axis between a first angular position and a second angular position and for axially displacing the actuator housing relative to the body along the folding axis between a first axial position and a second axial position; and
wherein a clutch gear of the drive assembly is rotatably and axially displaceably supported by the body and has at least one housing catch axially coupling the clutch gear to the actuator housing while allowing a relative rotation of the clutch gear and actuator housing; and
wherein a shaft section extends along the folding axis and comprises at least one groove circumferentially about a top surface of the shaft section and wherein an interior portion of the cover part comprises at least one slot having at least one pin affixed in at least one slot and engaging at least one groove on the top surface of the shaft section.
